(19) United States
(12) Patent Application Publication
(10) Pub. No.: US 2021/0088818 A1
(43) Pub. Date: Mar. 25, 2021

(54) DISPLAY DEVICE

(71) Applicant: InnoLux Corporation, Miao-Li County (TW)

(72) Inventors: Hong-Sheng HSIEH, Miao-Li County (TW); Yu-Sheng CHEN, Miao-Li County (TW); Bo-Hao SONG, Miao-Li County (TW)

(21) Appl. No.: 17/000,664

(22) Filed: Aug. 24, 2020

(30) Foreign Application Priority Data
Sep. 20, 2019 (CN) 201910891535.5

(51) Int. Cl. G02F 1/1345; G02F 1/1335

(52) U.S. Cl. CPC G02F 1/1345; G02F 2202/22; G02F 1/133528

(57) ABSTRACT

A display device is provided. The display device includes a display having a display area. The display includes a first substrate and an antistatic layer. The first substrate has a first side and a second side, the second side is opposite to the first side. The antistatic layer is disposed on the first side and has a plurality of hollow areas. At least a portion of the antistatic layer overlaps the display area in a normal direction of the first substrate.

### CROSS REFERENCE TO RELATED APPLICATIONS

This application claims priority of China Patent Application No. 201910891535.5, filed on Sep. 20, 2019, the entirety of which is incorporated by reference herein.

### BACKGROUND

### Technical Field

The present disclosure relates to a display device, and in particular it relates to a display device having an antistatic layer.

### Description of the Related Art

Electronic products equipped with display panels have become indispensable necessities in modern society. With the flourishing development of these portable electronic products, consumers have high expectations regarding their quality, functionality, and price.

Display panels are widely used in various spaces and environments, and the requirements for reducing the impact of ambient light sources on the use of observers are becoming more stringent.

The display devices that currently exist have not been satisfactory in all respects. Therefore, the development of a structural design that can improve the performance of display devices is still one of the goals that the industry is currently aiming at.

### SUMMARY

In accordance with some embodiments of the present disclosure, a display device is provided. The display device includes a display having a display area. The display includes a first substrate and an antistatic layer. The first substrate has a first side and a second side, the second side is opposite to the first side. The antistatic layer is disposed on the first side and has a plurality of hollow areas. At least a portion of the antistatic layer overlaps the display area in a normal direction of the first substrate.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1 is a cross-sectional diagram of a display device in accordance with some embodiments of the present disclosure;

FIG. 2A is a top-view diagram of an antistatic layer of a display device in accordance with some embodiments of the present disclosure;

FIG. 2B is a partially enlarged schematic view of an antistatic layer of a display device in accordance with some embodiments of the present disclosure;

FIGS. 3A to 3C are top-view diagrams of an antistatic layer of a display device in accordance with some embodiments of the present disclosure;

FIGS. 4A to 4D are top-view diagrams of an antistatic layer of a display device in accordance with some embodiments of the present disclosure;

FIG. 5 is a cross-sectional diagram of a display device in accordance with some embodiments of the present disclosure;

FIG. 6 is a cross-sectional diagram of a display device in accordance with some embodiments of the present disclosure.

### DETAILED DESCRIPTION

The display device provided in the present disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent that the exemplary embodiments set forth herein are used merely for the purpose of illustration. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments.

It should be understood that the elements or devices in the drawings of the present disclosure may be present in any form or configuration known to those with ordinary skill in the art. In addition, in the embodiments, relative expressions are used. For example, “lower”, “bottom”, “higher” or “top” are used to describe the position of one element relative to another. It should be appreciated that if a device is flipped upside down, an element that is “lower” will become an element that is “higher”. It should be understood that the descriptions of the exemplary embodiments are intended to be read in connection with the accompanying drawings, which are to be considered part of the entire written description. The drawings are not drawn to scale. In fact, the size of the element may be arbitrarily enlarged or reduced in order to clearly express the features of the present disclosure.

In addition, the expressions “a first material layer is disposed on or over a second material layer” may indicate that the first material layer is in direct contact with the second material layer, or that the first material layer is not in direct contact with the second material layer, there being one or more intermediate layers disposed between the first material layer and the second material layer.

In addition, it should be understood that, although the terms “first”, “second”, “third” etc. may be used herein to describe various elements, components, or portions, these elements, components, or portions should not be limited by these terms. These terms are only used to distinguish one element, component, or portion from another element, component, or portion. Thus, a first element, component, or portion discussed below could be termed a second element, component, or portion without departing from the teachings of the present disclosure.

The terms “about”, “approximately”, or “substantially” typically mean +/−20% of the stated value, or +/−10% of the stated value, or +/−5% of the stated value, or +/−3% of the stated value, or +/−2% of the stated value, or +/−1% of the stated value, or +/−0.5% of the stated value. The stated value of the present disclosure is an approximate value. When there is no specific description, the stated value includes the meaning of “about”, “approximately”, or “substantially”. In addition, the term “in a range from the first value to the second value” or “ranges from the first value to the second value” means that the range includes the first value, the second value and other values between them.

In accordance with some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

The display panel is widely used in various spaces and environments. However, the external environment light source that illuminates the display panel will cause light reflection and causes interference to the user when observing the display panel. The requirements of the reduction of the reflectivity of the display panel are becoming stricter. The general approach involves reducing the overall reflectivity of the display panel by reducing the thickness of the reflective elements in the display panel. However, when the element is become thinner, the characteristics or function of the element per se may be reduced. The above approach has a limited effect. Therefore, it is expected that the reflectivity of the display panel can be reduced by other methods.

In accordance with some embodiments of the present disclosure, the provided display device includes an antistatic layer having a hollow area, so that the area occupied by the antistatic layer can be reduced. Therefore, the reflectivity of the antistatic layer can be further reduced, or the image effect of the display device can be improved, or the applicability of the display device in various environments (for example, indoor, outdoor, or in-vehicle environment) can be enhanced.

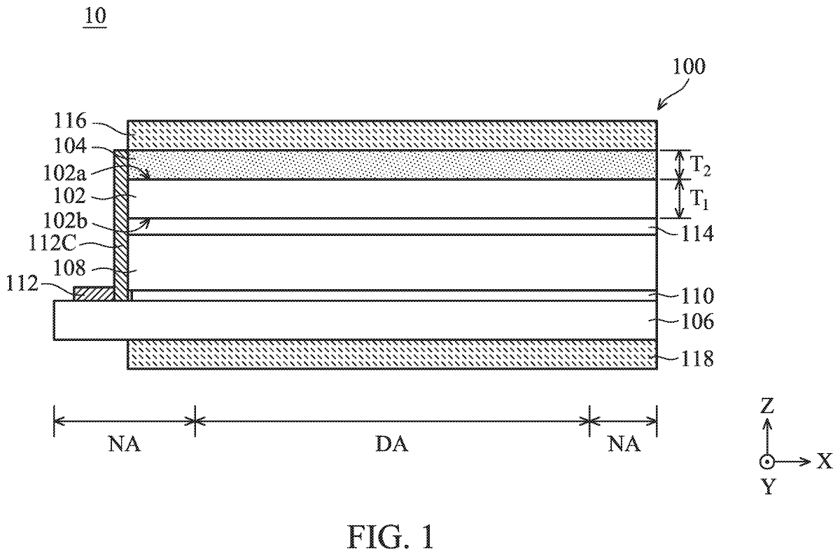

Refer to FIG. 1, which is a cross-sectional diagram of a display device 10 in accordance with some embodiments of the present disclosure. It should be understood that in accordance with some embodiments, additional features may be added to the display device 10 described below. In some other embodiments, some features of the display device 10 described below may be replaced or omitted.

In accordance with some embodiments, the display device 10 may include a flexible display device, a touch display device, a tiled display device, or a curved display device, but the present disclosure is not limited thereto.

As shown in FIG. 1, the display device 10 may include a display 100, and the display 100 may have a display area DA and a non-display area NA. In some embodiments, the non-display area NA may be disposed adjacent to the display area DA. For example, the non-display area NA may surround the display area DA. Furthermore, the display 100 may include a first substrate 102 and an antistatic layer 104, and the antistatic layer 104 may be disposed on the first substrate 102. In detail, the first substrate 102 may have a first side 102a and a second side 102b, the second side 102b is opposite to the first side 102a, the first side 102a and the second side 102b are located on opposite sides, and the antistatic layer 104 may be disposed on the first side 102a of the first substrate 102.

Furthermore, the first substrate 102 may have a first thickness T₁. In some embodiments, the first thickness T₁ may be in a range from 0.01 millimeters (mm) to 20 millimeters (mm) (i.e. 0.01 mm≤first thickness T₁≤20 mm), or from 0.1 mm to 10 mm, such as 1.5 mm, 2 mm, or 5 mm. In accordance with some embodiments, the first thickness T₁ refers to the maximum thickness of the first substrate 102 in a normal direction of the first substrate 102 (for example, the Z direction shown in the figure).

In addition, in accordance with the embodiments of the present disclosure, an optical microscopy (OM), a scanning electron microscope (SEM), a film thickness profiler (α-step), an ellipsometer, or another suitable means may be used to measure the thickness, width, or area of the elements, or distance between the elements, but the present disclosure is not limited thereto.

In some embodiments, the material of the first substrate 102 may include glass, quartz, sapphire, polycarbonate (PC), polyimide (PI), polyethylene terephthalate (PET), rubber, fiberglass, ceramic, another suitable material, or a combination thereof, but it is not limited thereto. In some embodiments, the first substrate 102 may include a metal-glass fiber composite plate, a metal-ceramic composite plate, a printed circuit board, or the like.

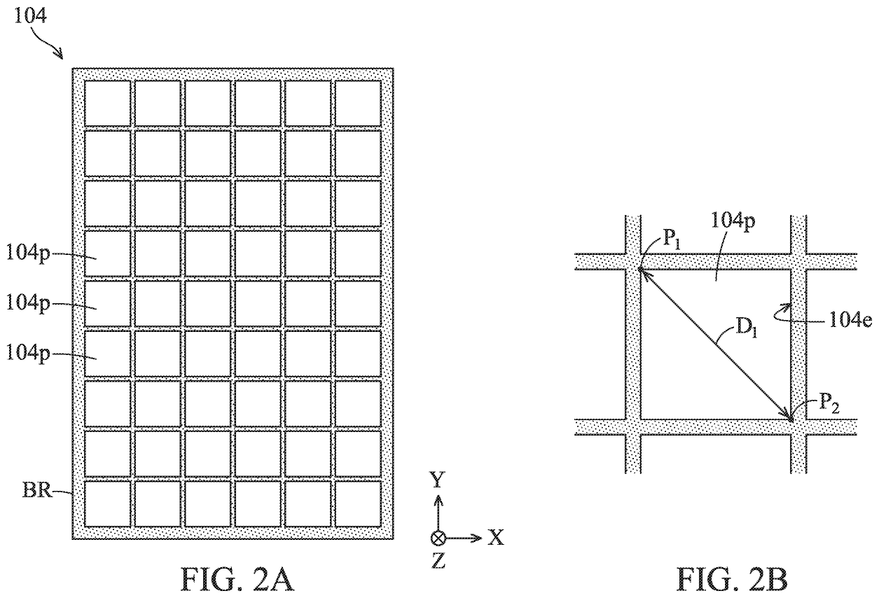

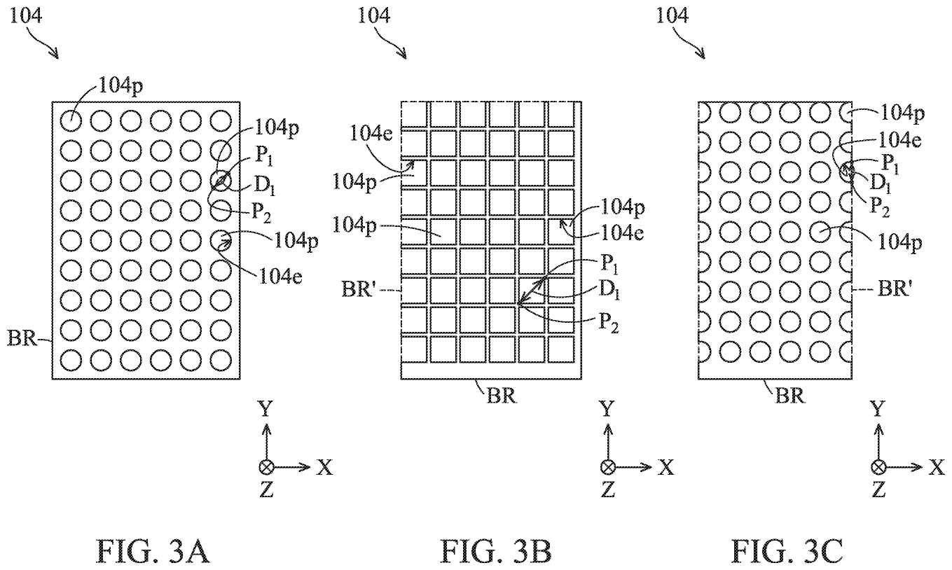

In addition, as shown in FIG. 2A, the antistatic layer 104 may have a plurality of hollow areas 104p. For example, the antistatic layer 104 may be patterned to have several hollow areas 104p. The detailed aspects of the hollow area 104p will be described later. As shown in FIG. 1 and FIG. 2A, at least a portion of the antistatic layer 104 may overlap the display area DA in the normal direction (e.g., the Z direction) of the first substrate 102. In some embodiments, at least a portion of the antistatic layer 104 also overlaps the non-display area NA in the normal direction (e.g., the Z direction) of the first substrate 102.

As shown in FIG. 1, in some embodiments, the antistatic layer 104 may be in contact with the first side 102a of the first substrate 102. In accordance with some embodiments, the antistatic layer 104 may reduce the accumulation of charge on the first side 102a. In some embodiments, by reducing the thickness of the antistatic layer 104, the reflectivity of the antistatic layer 104 may be reduced, thereby improving the image presenting effect of the display device 10.

Specifically, the antistatic layer 104 may have a second thickness T₂. In some embodiments, the second thickness T₂ may be in a range from 50 Angstroms (Å) to 300 Angstroms (Å) (i.e. 50 Å≤second thickness T₂≤300 Å), from 100 Å to 250 Å, or from 100 Å to 200 Å, such as 110 Å, 120 Å, 130 Å, 140 Å, or 150 Å. In accordance with some embodiments, the second thickness T₂ refers to the maximum thickness of the antistatic layer 104 in the normal direction (e.g., the Z direction) of the first substrate 102. The above-mentioned maximum thickness may be the maximum thickness in any cross-sectional image of the structure obtained by the measuring instrument.

It should be understood that if the second thickness T₂ of the antistatic layer 104 is too large (e.g., greater than 300 Å), the effect of reducing the reflectivity may not be significant. On the other hand, if the second thickness T₂ of the antistatic layer 104 is too small (e.g., less than 50 Å), the antistatic effect of the antistatic layer 104 may be affected.

In some embodiments, the material of the antistatic layer 104 may include a conductive material, such as a conductive material with a high light transmittance. Specifically, in some embodiments, the material of the antistatic layer 104 may include, but is not limited to, a transparent conductive material such as a transparent conductive oxide (TCO). For example, the transparent conductive oxide may include, but is not limited to, indium tin oxide (ITO), tin oxide (SnO), zinc oxide (ZnO), indium zinc oxide (IZO), indium gallium zinc oxide (IGZO), indium tin zinc oxide (ITZO), antimony tin oxide (ATO), antimony zinc oxide (AZO), another suitable material, or a combination thereof.

As shown in FIG. 2A, in some embodiments, the antistatic layer 104 may have the hollow areas 104p through a patterning process. In some embodiments, the patterning process may include a laser process, a femtosecond laser process, or a combination thereof, but it is not limited thereto. In some other embodiments, the patterning process may include a photolithography process or an etching process. The photolithography process may include photoresist coating (such as spin coating), soft baking, hard baking, mask alignment, exposure, post-exposure baking, photoresist development, cleaning or drying and so on, but it is not limited thereto. The etching process may include a dry etching process or a wet etching process, but it is not limited thereto.

In addition, as shown in FIG. 1, in some embodiments, the display 100 may further include a second substrate 106. The second substrate 106 may be disposed on the second side 102b of the first substrate 102 and opposite to the first substrate 102.

According to the foregoing, the display 100 may include the display area DA and the non-display area NA. In accordance with some embodiments, the area of the display area DA and the non-display area NA may be defined substantially by a sealant (not illustrated) between the first substrate 102 and the second substrate 106. In detail, the area inside the sealant may serve as the display area DA, and the area outside the sealant (including the area overlapping the sealant) may serve as the non-display area NA, but it is not limited thereto. In some other embodiments, the area where the image is displayed is defined as the display area DA, and the area outside the display area is defined as the non-display area NA.

In some embodiments, the material of the second substrate 106 may include glass, quartz, sapphire, polycarbonate (PC), polyimide (PI), polyethylene terephthalate (PET), rubber, fiberglass, ceramic, another suitable material, or a combination thereof, but it is not limited thereto. In some embodiments, the second substrate 106 may include a metal-glass fiber composite plate, a metal-ceramic composite plate, a printed circuit board, or the like. In addition, the material of the second substrate 106 may be the same as or different from the material of the first substrate 102.

As shown in FIG. 1, in some embodiments, the display 100 may include a liquid-crystal layer 108, and the liquid-crystal layer 108 may be disposed between the first substrate 102 and the second substrate 106. In some embodiments, the liquid-crystal layer 108 may include liquid-crystal molecules (not illustrated). In some embodiments, different electric fields may be applied to the liquid-crystal layer 108 to change the arrangement orientation of the liquid-crystal molecules, thereby adjusting the displayed image.

In some embodiments, the material of the liquid-crystal layer 108 may include nematic liquid-crystal, smectic liquid-crystal, cholesteric liquid-crystal, blue-phase liquid-crystal, another suitable liquid-crystal material or a combination thereof, but it is not limited thereto. However, in accordance with some other embodiments, instead of the liquid-crystal layer 108, a modulation material having different properties (for example, dielectric constant) that can be adjusted by applying an electric field or other means may be used.

In some embodiments, the display 100 may further include a driving layer 110. The driving layer 110 may be disposed on the second substrate 106 and adjacent to the second side 102b of the first substrate 102. In other words, the driving layer 110 may be disposed between the first substrate 102 and the second substrate 106. The driving layer 110 may be used to provide an electric field applied to the liquid-crystal layer 108, but it is not limited thereto.

Specifically, the driving layer 110 may include, for example, an active driving circuit or a passive driving circuit. In accordance with some embodiments, the driving layer 110 may include transistors (e.g., switching transistors or driving transistors, etc.), data lines, scan lines, dielectric layers, or other circuits and so on, but it is not limited thereto. The switching transistor may be used to control the switching on/off of the pixels of the display 100. In some embodiments, the transistor may include low-temperature polysilicon (LTPS), indium gallium zinc oxide (IGZO), amorphous silicon (a-Si), or a combination thereof, but it is not limited thereto. In some embodiments, different transistors may include different semiconductor materials, but are not limited thereto. In some embodiments, the driving layer 110 may control the pixels by an external integrated circuit (IC), a microchip, or the like.

In some embodiments, a conductive pad 112 may be disposed in the non-display area NA. The conductive pad 112 may be disposed on the second substrate 106. For example, the conductive pad 112 and the driving layer 110 may be formed by the same process, but it is not limited thereto. In addition, the conductive pad 112 may be electrically connected to an external circuit and have a fixed potential. For example, the fixed potential may be ground or common electrode potential. Moreover, in some embodiments, the antistatic layer 104 may be electrically connected to the conductive pad 112. In other words, in some embodiments, the antistatic layer 104 may be grounded. In some embodiments, the antistatic layer 104 may also be electrically connected to the conductive pad 112 through a conductive adhesive 112C. In some embodiments, the conductive adhesive 112C may be, for example, silver glue, gold glue, conductive tape, another suitable conductive material, or a combination thereof, but it is not limited thereto. In some embodiments, a portion of the conductive adhesive 112C may be disposed on the sidewall of the display 100 along the normal direction of the first substrate 102, and directly contact and electrically connect with the antistatic layer 104 and the conductive pad 112, so that the antistatic layer 104 and the conductive pad 112 may have the same potential.

As shown in FIG. 1, in some embodiments, the display 100 may include a black matrix (not illustrated) or a color filter layer 114. The color filter layer 114 may be disposed between the first substrate 102 and the liquid-crystal layer 108. In some embodiments, the color filter layer 114 may be disposed on the second side 102b of the first substrate 102. The color filter layer 114 may be used to filter or adjust the optical properties of the light that passes through the liquid-crystal layer 108. In some embodiments, the color filter layer 114 may include a red filter layer, a green filter layer, a blue filter layer, other filter layers with suitable colors or properties, or a combination thereof, but it is not limited thereto.

In some embodiments, the display 100 may include a first polarizing plate 116 and a second polarizing plate 118. The first polarizing plate 116 may be disposed on the first side 102a of the first substrate 102 and on the antistatic layer 104. The second polarizing plate 118 may be disposed on the second side 102b of the first substrate 102 and below the driving layer 110. The first polarizing plate 116 and the liquid-crystal layer 108 may be located on opposite sides of the first substrate 102. The second polarizing plate 118 and the liquid-crystal layer 108 may be located on opposite sides of the second substrate 106.

In some embodiments, the materials of the first polarizing plate 116 and the second polarizing plate 118 may include polyvinyl alcohol (PVA), or another suitable material, but is not limited thereto. For example, in some embodiments, the first polarizing plate 116 and the second polarizing plate 118 may include two protective layers and a polyvinyl alcohol film interposed between the protective layers. For example, the protective layer may include triacetyl cellulose (TAC) membrane, but it is not limited thereto. However, in some other embodiments, the first polarizing plate 116 and/or the second polarizing plate 118 may be replaced with a metallic wire grid polarizer (WGP).

In addition, in some embodiments, the material of the first polarizing plate 116 and/or the second polarizing plate 118 may further include a plurality of conductive particles (not illustrated) and the conductive particles may be in contact with the antistatic layer 104. The antistatic effect of the display 100 may be further increased.

In some embodiments, the material of the aforementioned conductive particles may include at least a metal material. For example, the metal material may include copper (Cu), aluminum (Al), indium (In), ruthenium (Ru), tin (Sn), gold (Au), platinum (Pt), zinc (Zn), silver (Ag), titanium (Ti), lead (Pb), nickel (Ni), chromium (Cr), magnesium (Mg), palladium (Pd), copper alloy, aluminum alloy, indium alloy, ruthenium alloy, tin alloy, gold alloy, platinum alloy, zinc alloy, silver alloy, titanium alloy, lead alloy, nickel alloy, chromium alloy, magnesium alloy, palladium alloy, another suitable material, or a combination thereof, but it is not limited thereto.

In some embodiments, the resistance of the first polarizing plate 116 may be in a range from 10\hat{ }9 ohms per square (Ω/□) to 10\hat{ }12 ohms per square (i.e. 10\hat{ }9Ω/□≤the resistance of the first polarizing plate 116≤10\hat{ }12Ω/□). In some embodiments, the resistance of the second polarizing plate 118 may be similar to the resistance of the first polarizing plate 116, and thus will not be repeated herein.

According to the foregoing, in accordance with some embodiments, the display 100 may include a liquid-crystal display. The liquid-crystal display may include a twisted nematic (TN) type liquid-crystal panel, a super twisted nematic (STN) type liquid-crystal panel, a double layer super twisted nematic (DSTN) type liquid-crystal panel, a vertical alignment (VA) type liquid-crystal panel, an in-plane switching (IPS) type liquid-crystal panel, a cholesteric type liquid-crystal panel, a blue phase type liquid-crystal panel, a fringe field switching (FFS) type liquid-crystal panel, or another suitable display panel, but the present disclosure is not limited thereto.

It should be understood that, in different embodiments, those skilled in the art may adjust the element configuration of the aforementioned display 100 according to actual needs, or add the element that is needed. For example, in some embodiments, the display 100 may further include an alignment film, a light-shielding layer, a prism, a brightness enhancement film (BEF), a light-guiding plate, a diffusion plate, a reflection sheet, and a quantum dot film (QD film), another suitable component or a combination thereof, but the present disclosure is not limited thereto.

In addition, in some embodiments, the display device 10 may include a backlight module (not illustrated) adjacent to the display 100, and the backlight module may provide the light source for the display 100. In some embodiments, the backlight module may include an inorganic light-emitting diode (LED), such as a mini LED or a micro LED, or an organic light-emitting diode (OLED), electroluminescence elements, another suitable light-emitting element, or a combination thereof, but the present disclosure is not limited thereto.

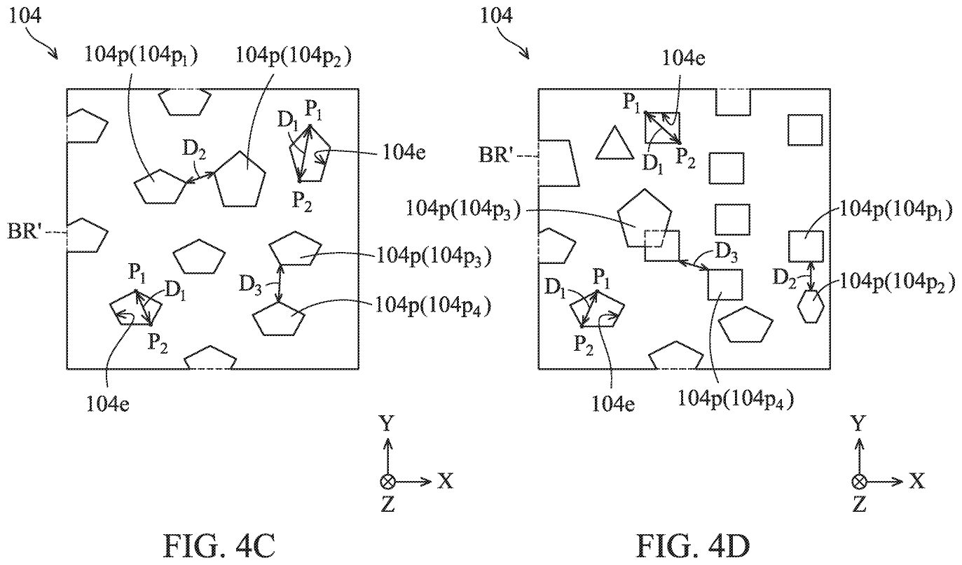

Next, refer to FIG. 2A and FIG. 2B. FIG. 2A is a top-view diagram of the antistatic layer 104 of the display device 10 in accordance with some embodiments of the present disclosure. FIG. 2B is a partially enlarged schematic view of the antistatic layer 104 in accordance with some embodiments of the present disclosure. According to the foregoing, the antistatic layer 104 may have the hollow areas 104p. In some embodiments, the hollow area 104p may further reduce the reflectivity of the antistatic layer 104. In some embodiments, the hollow areas 104p may be connected. For example, in some embodiments, one hollow area 104p may have a pentagonal shape and another hollow area 104p may have a rectangular shape, and the edges of these two hollow areas 104p may be joined to form a closed connected hollow area (as shown in FIG. 4D).

As shown in FIG. 2B, the hollow area 104p may have an edge 104e, and the edge 104e may define the shape and size of the hollow area 104p. In some embodiments, there may be a first distance D₁ between two points on the edge 104e of the hollow area 104p, the first distance D₁ is the maximum distance between two points on the edge 104e of the hollow area 104p. In addition, the first distance D₁ and the edge 104e may have two intersection points, point P₁ and point P₂.

In some embodiments, as shown in FIG. 2A and FIG. 2B, the hollow area 104p may substantially have a rectangular structure, and an extending direction of the edge 104e may be, for example, the X direction or the Y direction shown in the figure. In some embodiments, when it is viewed in the Z direction, the X direction or the Y direction are different from the direction of the data line, scan line, or black matrix (not illustrated). That is, the edge 104e may have an angle between the data line, scan line, or black matrix. With such a configuration, the risk of a moire pattern occurring between the hollow areas 104p and the data lines or scan lines can be reduced.

In some embodiments, the first distance D₁ may be greater than zero and less than or equal to the first thickness T₁ of the first substrate 102. In addition, the first substrate 102 may be single-layered or multilayered, and the first thickness T₁ of the first substrate 102 means the total thickness of the single-layered or multilayered first substrate 102. In some embodiments, the first distance D₁ may be less than or equal to 90%, 70%, 50%, 30%, or 10% of the first thickness T₁ of the first substrate 102. In addition, in some embodiments, the first distance D₁ may be greater than or equal to 5%, 10%, 25%, or 50% of the first thickness T₁ of the first substrate 102.

It should be understood that if the first distance D₁ of the hollow area 104p is too large (e.g., greater than the first thickness T₁), when the static electricity is in contact with the surface of the display device and has not been guided away, the static electricity that is left may cause electrostatic coupling and generate an electric field near the hollow area 104p, therefore the arrangement of adjacent liquid-crystal molecules may be affected, which may affect the display quality of the display device. On the other hand, if the first distance D₁ of the hollow area 104p is too small (e.g., less than 5% of the first thickness T₁), the effect of reducing the reflectivity of the antistatic layer 104 may be limited.

In addition, in some embodiments, the ratio of a total area of the hollow areas 104p to an area of the display area DA may be greater than or equal to 50% (i.e. total of the hollow areas 104p/area of the display area DA); 50%). For example, it may be greater than or equal to 55%, 60%, 65%, or 70%. In other words, in some embodiments, the ratio of the area of the antistatic layer 104 (excluding the hollow areas 104p) to the area of the display area DA may be less than 50% (i.e. area of the antistatic layer 104/area of the display area DA<50%). For example, it may be less than 45%, 40%, 35%, or 30%.

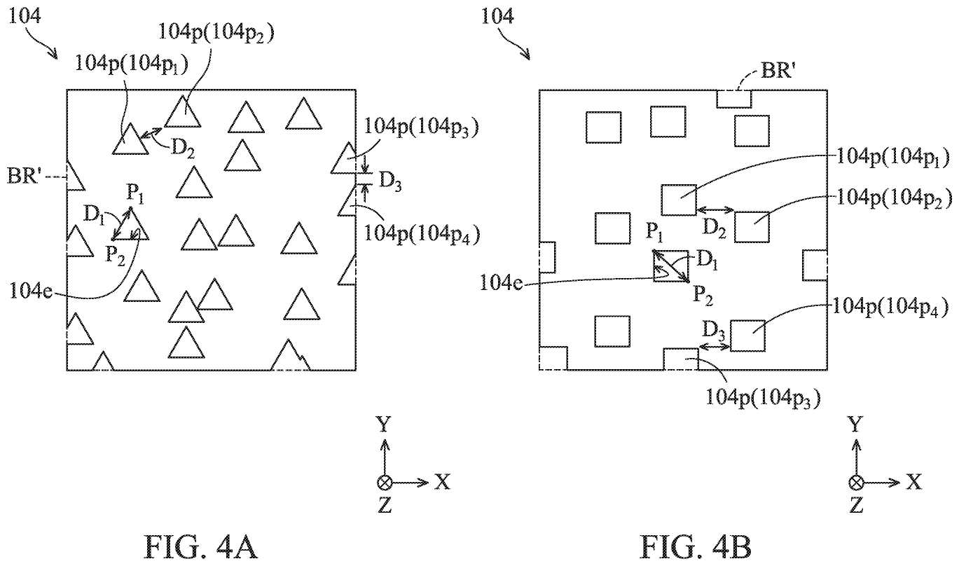

For example, in the top-view perspective, the antistatic layer 104 may have an area A surrounded by a closed boundary line BR before it is patterned. After the antistatic layer 104 is patterned, the hollow area 104p may have the edge 104e, and the edge 104e defines the shape and size of the hollow area 104p and the area of the hollow area 104p may be obtained. Furthermore, the area of the antistatic layer 104 before it is patterned is subtracted from the area of the hollow area 104p to obtain the area of the patterned antistatic layer. In addition, when the patterned antistatic layer 104 has a non-closed hollow area 104p, a boundary line BR′ (as shown in FIG. 3B) may be used to define the area of the hollow area 104p. The boundary line BR′ may be the extension line of the edge of the hollow area 104p.

In accordance with some embodiments, the area of the hollow area 104p and the area of the display area DA refer to the areas of the hollow area 104p and the display area DA in the normal direction (e.g., the Z direction) of the first substrate 102.

Next, refer to FIGS. 3A to 3C, which are top-view diagrams of the antistatic layer 104 of the display device 10 in accordance with some other embodiments of the present disclosure. As shown in FIGS. 3A to 3C, in some embodiments, the hollow area 104p of the antistatic layer 104 may have a rectangular or circular shape. However, it should be understood that in various embodiments, the shape of the hollow area 104p may be adjusted according to needs. For example, in accordance with some other embodiments, the hollow area 104p may have a triangular shape, a pentagon shape, a hexagon shape, any polygon shape, ellipse shape, irregular shape, another suitable shape, or a combination thereof. In addition, in accordance with some embodiments, the hollow area 104p may have a closed area. For example, the closed area may form the various aforementioned shapes. However, in accordance with some other embodiments, the hollow area 104p may also include a non-closed area (i.e. an open area), such as the non-closed area that is defined by a partial boundary as shown in FIG. 3B and FIG. 3C.

In addition, as shown in FIG. 2A and FIG. 3A, in some embodiments, the outermost edge of the antistatic layer 104 may have a closed boundary line BR, and the hollow areas 104p may be surrounded by four linear boundary lines BR, and the hollow areas 104p are closed. In some other embodiments, as shown in FIG. 3B and FIG. 3C, the antistatic layer comprises a plurality of boundary lines BR, it should be noted that, the antistatic layer 104 may have a non-linear boundary line BR. For example, it may have a portion of the linear boundary line BR and a portion of the non-linear boundary line BR (for example, an arc-shaped boundary line BR), but the present disclosure is not limited thereto. In some embodiments, as shown in FIG. 3B and FIG. 3C, the hollow areas 104p may be partially closed and partially non-closed. In addition, in some embodiments, as shown in FIGS. 3A to 3C, the hollow areas 104p may be arranged in a regular manner.

Next, refer to FIGS. 4A to 4D. FIGS. 4A to 4D are top-view diagrams of the antistatic layer 104 of the display device 10 in accordance with some other embodiments of the present disclosure. As shown in FIGS. 4A to 4D, in some embodiments, the antistatic layer 104 may have hollow areas 104p having different shapes or sizes. For example, as shown in FIG. 4D, in some embodiments, the shapes of at least two of the hollow areas 104p are different from each other. In some embodiments, the hollow areas 104p may be arranged in an irregular manner.

Referring to FIGS. 4A to 4D, in some embodiments, two of the hollow areas 104p (for example, labeled as 104p₁ and 104p₂ for convenience of description) are separated by a second distance D₂, and the other two of the hollow areas 104p (for example, labeled as 104p₃ and 104p₄ for convenience of description) are separated by a third distance D₃. In accordance with some embodiments, the second distance D₂ may be different from the third distance D₃. In addition, in some embodiments, the first distance D₁ of the hollow area 104p may also be different from the second distance D₂ and/or the third distance D₃.

In accordance with some embodiments, the second distance D₂ refers to the minimum distance between two adjacent hollow area 104p₁ and hollow area 104p₂ in a direction that is perpendicular to the normal direction of the first substrate 102, the term “adjacent” means that no other hollow area 104p exists between the shortest connection line of two hollow areas 104p. In accordance with some embodiments, the third distance D₃ refers to the minimum distance between two adjacent hollow area 104p₃ and hollow area 104p₄ in a direction that is perpendicular to the normal direction of the first substrate 102.

In accordance with some embodiments, the hollow areas 104p having different spacing from each other or the hollow areas 104p having different shapes can reduce interference between the antistatic layer 104 and other elements in the display 100 that are arranged in a regular manner. For example, the risk of interference between the hollow areas 104p and data lines, scan lines or black matrix (not illustrated) can be reduced.

According to the foregoing, in accordance with some embodiments, by adjusting the second thickness T₂ of the antistatic layer 104 and the proportion, shape, or distribution of the hollow areas 104p of the antistatic layer 104, the antistatic layer 104 can have a suitable resistance and reflectivity.

Specifically, in some embodiments, the resistance of the antistatic layer 104 may be in a range from 100 ohms per square (Ω/□) to 10000 ohms per square (i.e. 100Ω/□≤resistance of antistatic layer 104≤10000Ω/□), from 1000 ohms per square to 8000 ohms per square, or from 2000 ohms per square to 7000 ohms per square.

In addition, in some embodiments, the reflectivity of the antistatic layer 104 may be in a range from 0% to 10% (i.e. 0%<reflectivity of the antistatic layer 104≤10%), from 0.001% to 5%, or from 0.01% to 0.5%. The reflectivity of the antistatic layer 104 can be measured by a suitable method known in the art. For example, in accordance with some embodiments, the reflectivity may be measured by using an integrating sphere.

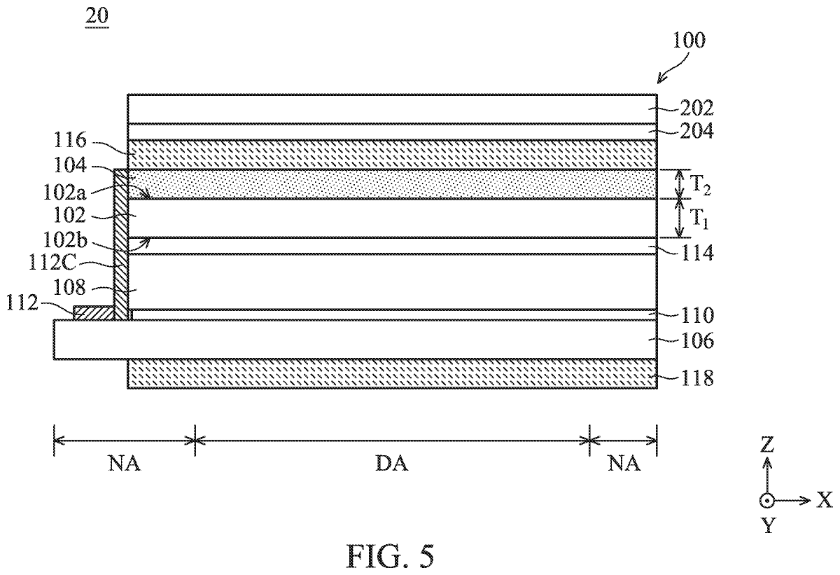

Next, refer to FIG. 5, which is a cross-sectional diagram of a display device 20 in accordance with some other embodiments of the present disclosure. It should be understood that the same or similar components or elements in above and below contexts are represented by the same or similar reference numerals. The materials, manufacturing methods and functions of these components or elements are the same or similar to those described above, and thus will not be repeated herein.

The display device 20 shown in FIG. 5 is substantially similar to the display device 10 shown in FIG. 1, the difference between them includes that in this embodiment, the display device 20 may further include a cover plate 202 and an adhesive layer 204. The cover plate 202 and the adhesive layer 204 may be disposed on the first polarizing plate 116, and the adhesive layer 204 may be disposed between the cover plate 202 and the first polarizing plate 116.

In some embodiments, the material of the cover plate 202 may include a glass material, but it is not limited thereto. In some embodiments, the glass material may include glass materials that have undergone chemical strengthening treatment and/or ion exchange treatment, such as soda-lime glass, lead glass, borosilicate glass, quartz glass, aluminosilicate glass, or another suitable glass material, but it is not limited thereto.

In some embodiments, the adhesive layer 204 may be formed of an adhesive material. In some embodiments, the adhesive layer 204 may include optical clear adhesive (OCA), optical clear resin (OCR), another suitable adhesive material, or a combination thereof. In some embodiments, the adhesive layer 204 may be transparent or translucent.

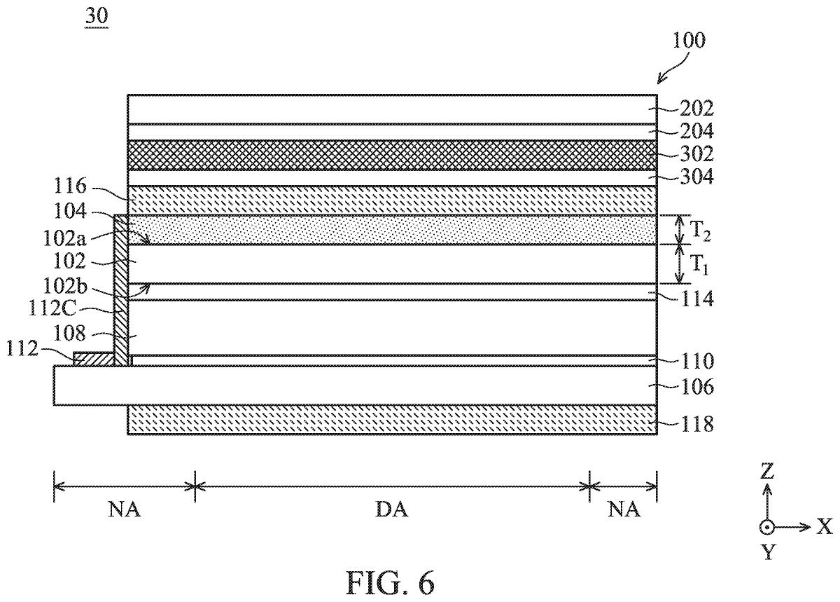

Next, refer to FIG. 6, which is a cross-sectional diagram of a display device 30 in accordance with some other embodiments of the present disclosure. The display device 30 shown in FIG. 6 is substantially similar to the display device 20 shown in FIG. 5, the difference between them includes that, in this embodiment, the display device 30 may further include a touch layer 302 and an adhesive layer 304. The touch layer 302 and the adhesive layer 304 may be disposed between the adhesive layer 204 and the first polarizing plate 116.

In some embodiments, the touch layer 302 may be disposed between the liquid-crystal layer 108 and the second substrate 106, and the touch layer 302 may be electrically connected to the driving layer 110. In some embodiments, the touch layer 302 may include touch electrodes (not illustrated) and wires (not illustrated). In some embodiments, the materials of the touch electrodes and the wires may include metal materials or transparent conductive materials, such as transparent conductive oxide (TCO). The transparent conductive oxide may include, but is not limited to, indium tin oxide (ITO), tin oxide (SnO), zinc oxide (ZnO), indium zinc oxide (IZO), indium gallium zinc oxide (IGZO), indium tin zinc oxide (ITZO), antimony tin oxide (ATO), antimony zinc oxide (AZO) or a combination thereof.

Furthermore, in some embodiments, the material of the adhesive layer 304 may be the same as or similar to the adhesive layer 204, and thus will not be repeated herein.

According to the foregoing, although the present disclosure only shows the embodiments taking the liquid-crystal display as the display 100, in accordance with some embodiments, the display 100 may not have a liquid-crystal layer 108. For example, the display 100 may be an inorganic light-emitting diode display or an organic light-emitting diode display in accordance with some embodiments.

The inorganic light-emitting diode display or the organic light-emitting diode display may include a light-emitting layer, and the antistatic layer 104 may be adjacent to the light-emitting layer. In some embodiments, the light-emitting layer may include an inorganic light-emitting diode, an organic light-emitting diode, another suitable light-emitting element, or a combination thereof, but it is not limited thereto. The inorganic light-emitting diode may include, for example, a mini light-emitting diode (mini LED), a micro light-emitting diode (micro LED), a quantum dot (QD), and a quantum dot light-emitting diode (QLED, QD-LED), or a combination thereof. In addition, the light-emitting diode may be a light-emitting diode with a vertical-type structure or a flip-chip type structure.

To summarize the above, in accordance with some embodiments of the present disclosure, the provided display device includes the antistatic layer having the hollow areas. Therefore, the reflectivity of the antistatic layer can be further reduced, or the image effect of the display device can be improved, or the applicability of the display device in various environments (for example, indoor, outdoor, or in-vehicle environment) can be enhanced.

Although some embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. In addition, each claim constitutes an individual embodiment, and the claimed scope of the present disclosure also includes the combinations of the claims and embodiments. The features of the various embodiments can be used in any combination as long as they do not depart from the spirit and scope of the present disclosure. The scope of protection of present disclosure is subject to the definition of the scope of the appended claims.

1. A display device, comprising:
a display having a display area, the display comprising:
a first substrate having a first side and a second side, wherein the second side is opposite to the first side; and
an antistatic layer disposed on the first side and having a plurality of hollow areas;
wherein at least a portion of the antistatic layer overlaps the display area in a normal direction of the first substrate.

2. The display device as claimed in claim 1, wherein a thickness of the antistatic layer is in a range from 50 angstroms to 300 angstroms.

3. The display device as claimed in claim 1, wherein a maximum distance is between two points on an edge of at least one of the plurality of hollow areas, and the maximum distance is greater than zero and is less than or equal to a thickness of the first substrate.

4. The display device as claimed in claim 3, wherein the maximum distance is greater than or equal to 5% of the thickness of the first substrate.

5. The display device as claimed in claim 1, wherein a ratio of a total area of the plurality of hollow areas to an area of the display area is greater than or equal to 50%.

6. The display device as claimed in claim 1, wherein a resistance of the antistatic layer is in a range from 100 ohms per square (Ω/□) to 10000 ohms per square.

7. The display device as claimed in claim 1, further comprising a conductive pad electrically connected to the antistatic layer, and the conductive pad has a fixed potential.

8. The display device as claimed in claim 1, further comprising a second substrate disposed on the second side and a conductive pad disposed on the second side, wherein the conductive pad is disposed on the second substrate and the antistatic layer is electrically connected to the conductive pad.

9. The display device as claimed in claim 1, wherein two of the plurality of hollow areas are separated by a first distance, and the other two of the plurality of hollow areas are separated by a second distance, and the first distance is different from the second distance.

10. The display device as claimed in claim 1, wherein the display further comprises a polarizing plate disposed on the first side of the first substrate, and a material of the polarizing plate comprises a plurality of conductive particles.

11. The display device as claimed in claim 10, wherein a resistance of the polarizing plate is in a range from 10\hat{ }9 ohms per square (Ω/□) to 10\hat{ }12 ohms per square.

12. The display device as claimed in claim 1, the display further having a non-display area adjacent to the display area, wherein at least another portion of the antistatic layer overlaps the non-display area in the normal direction of the first substrate.

13. The display device as claimed in claim 12, further comprising a conductive pad electrically connected to the antistatic layer, wherein the conductive pad is disposed in the non-display area.

14. The display device as claimed in claim 13, wherein the conductive pad is electrically connected to the antistatic layer through a conductive adhesive.

15. The display device as claimed in claim 1, wherein the plurality of hollow areas are connected.

16. The display device as claimed in claim 1, wherein the antistatic layer comprises a plurality of boundary lines, and the plurality of hollow areas is surrounded by the plurality of boundary lines.

17. The display device as claimed in claim 16, wherein a portion of the plurality of boundary lines is linear and a portion of the plurality of boundary lines is non-linear.

18. The display device as claimed in claim 1, wherein the plurality of hollow areas are partially closed and partially non-closed.

19. The display device as claimed in claim 1, wherein a reflectivity of the antistatic layer is in a range from 0% to 10%.

20. The display device as claimed in claim 10, further comprising a cover plate and an adhesive layer disposed on the polarizing plate.
